(19) United States
(12) Patent Application Publication
(10) Pub. No.: US 2026/0218756 A1
(43) Pub. Date: Jul. 30, 2026

(54) POWER TRANSMISSION DEVICE

(71) Applicant: EXEDY Corporation, Osaka (JP)

(72) Inventors: Hiroshi UEHARA, Osaka (JP); Takeshi HAYASHI, Osaka (JP)

(21) Appl. No.: 19/451,343

(22) Filed: Jan. 16, 2026

(30) Foreign Application Priority Data
Jan. 24, 2025 (JP) 2025-010705

(51) Int. Cl. F16D 3/12; F16D 3/66; F16D 7/02

(52) U.S. Cl. CPC F16D 3/12; F16D 3/66; F16D 7/025

(57) ABSTRACT

A power transmission device includes a flexible plate and a drive plate. The flexible plate is configured to receive a torque outputted from a prime mover. The drive plate is configured to be rotated unitarily with the flexible plate. The flexible plate includes a protruding portion protruding toward the drive plate in an axial direction. The drive plate has an annular shape. The drive plate is disposed radially inside the protrusion at an inner peripheral end thereof. The drive plate has a larger plate thickness than the flexible plate.

### CROSS-REFERENCE TO RELATED APPLICATIONS

This application is based on and claims the priority benefit of Japanese application No. 2025-010705 filed on January 24, 2025, the contents of which are incorporated herein by reference.

### TECHNICAL FIELD

The present invention relates to a power transmission device.

### BACKGROUND

A power transmission device disclosed in Japan Laid-open Patent Application Publication No. 2024-030506 includes a flywheel, a torque limiter, and a damper unit. The flywheel includes a flexible plate and an inertia ring. The torque limiter is attached to the inertia ring.

### SUMMARY OF THE INVENTION

It is an object of the present invention to provide a power transmission device obtainable at a low cost.

A power transmission device according to a first aspect includes a flexible plate and a drive plate. The flexible plate is configured to receive a torque outputted from a prime mover. The drive plate is configured to be rotated unitarily with the flexible plate. The flexible plate includes a protruding portion protruding toward the drive plate in an axial direction. The drive plate has an annular shape. The drive plate is disposed radially inside the protruding portion at an inner peripheral end thereof. The drive plate has a larger plate thickness than the flexible plate.

According to the configuration, the drive plate, having a larger plate thickness than the flexible plate, is attached to the flexible plate; hence, it is made possible to cause the drive plate to function as at least a part of an inertia ring. Because of this, the inertia ring can be omitted at least in part. It should be noted that the inertia ring is generally formed by casting, whereas the drive plate is generally formed by sheet metal processing or stamping of a metallic plate. Then, the drive plate, formed by sheet metal processing or stamping, is lower in cost than the inertia ring formed by casting. Because of this, the power transmission device is obtainable at a low cost. Besides, the drive plate is lower in stiffness than the inertia ring; however, the drive plate can be enhanced in stiffness by extending the inner peripheral end thereof to a position disposed radially inside the protruding portion of the flexible plate.

A power transmission device according to a second aspect relates to the power transmission device according to the first aspect and further includes a disc spring. The disc spring is disposed between the flexible plate and the drive plate in the axial direction. The disc spring is in contact with the protruding portion and the drive plate.

A power transmission device according to a third aspect relates to the power transmission device according to the second aspect and is configured as follows. The disc spring is in contact at an outer peripheral end portion thereof with the drive plate, while being in contact at an inner peripheral end portion thereof with the protruding portion.

A power transmission device according to a fourth aspect relates to the power transmission device according to the second aspect and is configured as follows. The disc spring is in contact at an outer peripheral end portion thereof with the protruding portion, while being in contact at an inner peripheral end portion thereof with the drive plate.

A power transmission device according to a fifth aspect relates to the power transmission device according to the first aspect and is configured as follows. The drive plate is in contact with the protruding portion.

A power transmission device according to a sixth aspect relates to the power transmission device according to any of the first to fifth aspects and is configured as follows. The drive plate includes an annular portion and a cylindrical portion. The annular portion extends in a circumferential direction. The cylindrical portion extends from an outer peripheral end of the annular portion in the axial direction.

A power transmission device according to a seventh aspect relates to the power transmission device according to any of the first to sixth aspects and further includes an inertia member. The inertia member is configured to be rotated unitarily with the flexible plate and the drive plate.

A power transmission device according to an eighth aspect relates to the power transmission device according to any of the first to seventh aspects and further includes a torque limiter. The torque limiter is attached to the flexible plate.

A power transmission device according to a ninth aspect relates to the power transmission device according to the eighth aspect and is configured as follows. The torque limiter includes a first side plate, a friction plate, a pressure plate, and an urging member. The first side plate is attached to the flexible plate. The friction plate is disposed to be rotatable relative to the first side plate. The pressure plate holds the friction plate in cooperation with the first side plate, with the friction plate interposed therebetween. The urging member urges the pressure plate toward the first side plate in the axial direction.

A power transmission device according to a tenth aspect relates to the power transmission device according to the ninth aspect and is configured as follows. The first side plate includes an annular portion and a cylindrical portion. The annular portion extends in a circumferential direction. The cylindrical portion extends from an outer peripheral end of the annular portion toward the flexible plate in the axial direction.

A power transmission device according to an eleventh aspect relates to the power transmission device according to the tenth aspect and is configured as follows. The cylindrical portion serves as an outer peripheral surface of the power transmission device.

A power transmission device according to a twelfth aspect relates to the power transmission device according to the tenth or eleventh aspect and is configured as follows. The flexible plate is in contact with an inner peripheral surface of the cylindrical portion.

A power transmission device according to a thirteenth aspect relates to the power transmission device according to any of the first to twelfth aspects and further includes a damper unit. The damper unit is attached to the flexible plate. The damper unit includes a first rotary member, a second rotary member, and an elastic member. The first rotary member receives the torque from the flexible plate. The second rotary member is disposed to be rotatable relative to the first rotary member. The elastic member elastically couples the first and second rotary members therethrough to each other.

Overall, according to the present invention, a power transmission device is obtainable at a low cost.

### BRIEF DESCRIPTION OF THE DRAWINGS

FIG. 1 is a cross-sectional view of a power transmission device.

FIG. 2 is a plan view of the power transmission device (shown without bolts) from which a torque limiter and a damper unit are detached.

FIG. 3 is an enlarged cross-sectional view of the power transmission device.

FIG. 4 is an enlarged cross-sectional view of the power transmission device.

FIG. 5 is a cross-sectional view of a power transmission device according to a modification.

FIG. 6 is a cross-sectional view a power transmission device according to another modification.

### DETAILED DESCRIPTION

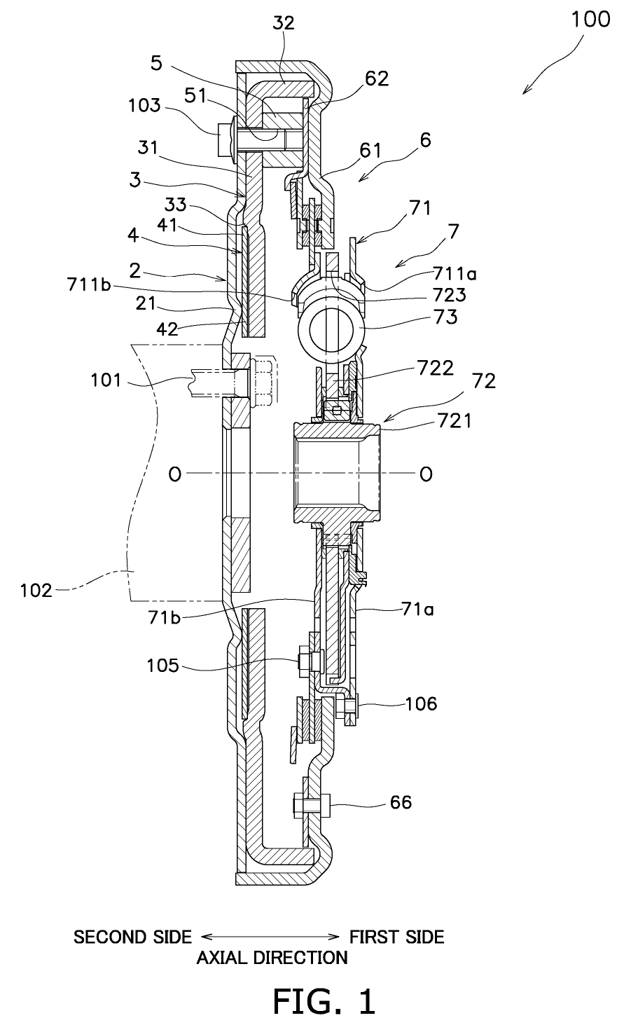

A power transmission device 100 according to the present preferred embodiment will be hereinafter explained with reference to drawings. It should be noted that in the following explanation, the term “axial direction” refers to an extending direction of a rotational axis O for the power transmission device 100. On the other hand, the term “circumferential direction” refers to a circumferential direction of an imaginary circle about the rotational axis O, whereas the term “radial direction” refers to a radial direction of the imaginary circle about the rotational axis O. Besides, the term “first side in the axial direction” means the right side in FIG. 1, whereas the term “second side in the axial direction” means the left side in FIG. 1.

FIG. 1 is a cross-sectional view of the power transmission device 100. As shown in FIG. 1, the power transmission device 100 includes a flexible plate 2, a drive plate 3, a disc spring 4, a plurality of first inertia blocks 5 (exemplary inertia members), a torque limiter 6, and a damper unit 7. The flexible plate 2, the drive plate 3, the disc spring 4, the inertia blocks 5, and the torque limiter 6 are configured to be rotated unitarily with each other. The torque limiter 6 and the damper unit 7, albeit rotatable relative to each other, are basically rotated unitarily with each other. When a torque inputted to the power transmission device 100 exceeds a predetermined value, the torque limiter 6 and the damper unit 7 are rotated relative to each other.

The power transmission device 100 is installed between a prime mover (omitted in illustration) and an output-side member (omitted in illustration). It should be noted that the prime mover refers to, for instance, an internal combustion engine. On the other hand, the output-side member refers to, for instance, an electric motor, a transmission, or so forth. The prime mover is disposed on the second side (the left side in FIG. 1) of the power transmission device 100 in the axial direction, whereas the output-side member is disposed on the first side (the right side in FIG. 1) of the power transmission device 100 in the axial direction. The power transmission device 100 is configured to limit a torque transmitted between the prime mover and the output-side member and attenuate fluctuations in torque.

### Flexible Plate

The flexible plate 2 is configured to receive the torque outputted from the prime mover. Specifically, the flexible plate 2 is attached to a crankshaft 102 by a plurality of bolts 101.

The flexible plate 2 has a disc shape. The flexible plate 2 has flexibility. The flexible plate 2 can be made of a steel plate or so forth; specifically, the flexible plate 2 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The flexible plate 2 has a plate thickness of, for instance, about 2 mm to 4 mm. While the power transmission device 100 is operating, the flexible plate 2 is capable of bending by about 0.3 mm to 0.5 mm in the axial direction, for instance, although the flexible plate 2 is not particularly limited in amount of bending to the above.

The flexible plate 2 includes a protruding portion 21. The protruding portion 21 protrudes to the first side in the axial direction. In other words, the protruding portion 21 protrudes toward the drive plate 3. The protruding portion 21 is made in the shape of an annulus extending in the circumferential direction.

### Drive Plate

The drive plate 3 is disposed on the first side of the flexible plate 2 in the axial direction. The drive plate 3 is configured to be rotated unitarily with the flexible plate 2. Specifically, the drive plate 3 is fastened to the flexible plate 2 by a plurality of bolts 103 screwed into the inertia blocks 5. The bolts 103 are disposed away from each other at equal intervals in the circumferential direction.

The drive plate 3 has an annular shape. The inner peripheral end of the drive plate 3 is disposed radially inside the protruding portion 21 of the flexible plate 2. The drive plate 3 has a larger plate thickness than the flexible plate 2. Unlike the flexible plate 2, the drive plate 3 does not have flexibility. In other words, the drive plate 3 does not basically bend, while the power transmission device 100 is operating. The drive plate 3 can be set to have a plate thickness of, for instance, about 5 mm to 7 mm.

The drive plate 3 can be made of a steel plate or so forth; specifically, the drive plate 3 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The drive plate 3 can be formed by sheet metal processing or stamping of a steel plate. Specifically, the drive plate 3 can be formed by single-stage stamping, progressive stamping, or transfer stamping.

The drive plate 3 includes a first annular portion 31 and a first cylindrical portion 32. The first annular portion 31 is made in the shape of an annulus extending in the circumferential direction. An outer peripheral part of the first annular portion 31 is in contact with the flexible plate 2 in the axial direction.

An inner peripheral part of the first annular portion 31 is disposed away from the flexible plate 2 at an interval in the axial direction. The first annular portion 31 includes a stepped portion 33.

The first cylindrical portion 32 extends from the outer peripheral end of the first annular portion 31 to the first side in the axial direction. In other words, the first cylindrical portion 32 extends from the outer peripheral end of the first annular portion 31 toward the torque limiter 6. The first cylindrical portion 32 is formed by bending an outer peripheral part of the drive plate 3. Because of this, the first cylindrical portion 32 is substantially equal in plate thickness to the first annular portion 31. The first cylindrical portion 32 overlaps with the inertia blocks 5 as seen in the radial direction.

### Disc Spring

The disc spring 4 is disposed axially between the flexible plate 2 and the drive plate 3. The disc spring 4 is in contact with the protruding portion 21 of the flexible plate 2 and the drive plate 3. When described in detail, an outer peripheral end portion 41 of the disc spring 4 is in contact with the drive plate 3. On the other hand, an inner peripheral end portion 42 of the disc spring 4 is in contact with the protruding portion 21 of the flexible plate 2. It should be noted that, while the power transmission device 100 is not operating, the outer peripheral end portion 41 of the disc spring 4 is not in contact with the flexible plate 2, while the inner peripheral end portion 42 thereof is not in contact with the drive plate 3.

The disc spring 4 is disposed between the flexible plate 21 and the inertia plate 22, while being compressed therebetween. The outer peripheral surface of the disc spring 4 is in contact with the stepped portion 33 of drive plate 3. Accordingly, the disc spring 4 is restricted from moving in the radial direction.

Thus, the disc spring 4 is in contact with the protruding portion 21; hence, when the flexible plate 2 bends in the axial direction, while the power transmission device 100 is operating, the protruding portion 21 slides against the disc spring 4, whereby an occurrence of resonance can be inhibited.

### Inertia Blocks

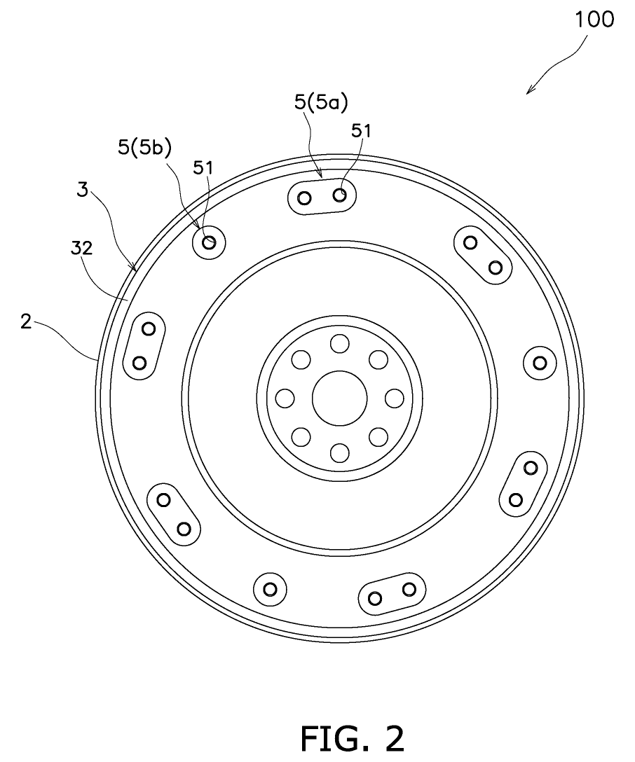

FIG. 2 is a plan view of the power transmission device 100 from which the torque limiter 6 and the damper unit 7 are detached. As shown in FIGS. 1 and 2, the inertia blocks 5 are disposed on the first side of the drive plate 3 in the axial direction. The inertia blocks 5 are disposed away from each other at intervals in the circumferential direction. The inertia blocks 5 are disposed in common on the circumference of an imaginary circle.

The inertia blocks 5 are configured to be rotated unitarily with the flexible plate 2 and the drive plate 3. Specifically, the plural inertia blocks 5 are composed of a plurality of first inertia blocks 5a and a plurality of second inertia blocks 5b. Each inertia block 5 includes at least one threaded hole 51. The at least one threaded hole 51 penetrates each inertia block 5 in the axial direction. When described in detail, each first inertia block 5a includes two threaded holes 51, whereas each second inertia block 5b includes one threaded hole 51. The first inertia blocks 5a and the second inertia blocks 5b are disposed such that the pattern "the first inertia block 5a, the second inertia block 5b, the first inertia block 5a" is repeated in the circumferential direction.

The first inertia blocks 5a and the second inertia blocks 5b are fixed to the drive plate 3 by the bolts 103. When described in detail, the bolts 103 are screwed into the threaded holes 51 of the inertia blocks 5, whereby the inertia blocks 5 are fixed to the drive plate 3. It should be noted that one bolt 103 is screwed into one of the two threaded holes 51 provided in each first inertia block 5a. The inertia blocks 5 may be fixed to the drive plate 3 by welding. The inertia blocks 5 are fixed to the outer peripheral part of the drive plate 3.

The inertia blocks 5 overlap with the first cylindrical portion 32 and a second cylindrical portion 612 as seen in the radial direction. When described in detail, the inertia blocks 5 are opposed to the inner peripheral surface of the first cylindrical portion 32. The inertia blocks 5 overlap with the first annular portion 31 and a second annular portion 611 as seen in the axial direction. When described in detail, the inertia blocks 5 overlap with the outer peripheral part of the first annular portion 31 and a first outer peripheral portion 611b of the second annular portion 611 as seen in the axial direction.

The inertia blocks 5 are disposed axially between the drive plate 3 and a first side plate 61. When described in detail, the inertia blocks 5 are axially sandwiched by the drive plate 3 and a second side plate 62. When described in more detail, the inertia blocks 5 are axially sandwiched by the first annular portion 31 and a second outer peripheral portion 622.

Each inertia block 5 is made in the form of, for instance, a nut. Each inertia block 5 has a thickness larger than the plate thickness of the first side plate 61. Besides, the thickness of each inertia block 5 is larger than the plate thickness of the drive plate 3. It should be noted that the thickness of each inertia block 5 means the axial dimension thereof.

### Torque Limiter

The torque limiter 6 is disposed to be rotatable about the rotational axis O. The torque limiter 6 is disposed on the first side of the drive plate 3 in the axial direction. The torque limiter 6 has an annular shape. The torque limiter 6 is configured to be attached to the flexible plate 2. When described in detail, the torque limiter 6 is attached to the flexible plate 2 through the inertia blocks 5 and the drive plate 3.

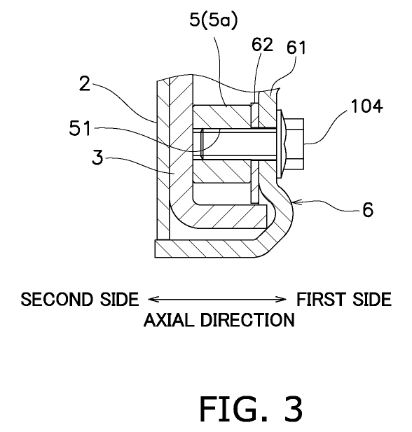

FIG. 3 is an enlarged cross-sectional view of the power transmission device 100 cut along a cross section in which bolts 104 for fastening the torque limiter 6 are disposed. As shown in FIG. 3, the bolts 104 are screwed into the threaded holes 51 of the first inertia blocks 5a, whereby the torque limiter 6 is attached to the inertia blocks 5. Specifically, one of the bolts 103 for fastening the drive plate 3 is screwed into one of two threaded holes 51 provided in each first inertia block 5a, whereas one of the bolts 104 for fastening the torque limiter 6 is screwed into the other of two threaded holes 51 provided in each first inertia block 5a. By contrast, the bolts 104 are not screwed into the second inertia blocks 5b. In other words, not only the drive plate 3 but also the torque limiter 6 is fixed to the first inertia blocks 5a; however, only the drive plate 3 is fixed to the second inertia blocks 5b. The bolts 103 for fastening the drive plate 3 are larger in number than the bolts 104 for fastening the torque limiter 6. The bolts 104 are disposed at equal intervals in the circumferential direction.

The torque limiter 6 is configured to limit the torque transmitted between the flexible plate 2 and the damper unit 7. In other words, the torque limiter 6 is configured to restrict transmission of the torque in the power transmission device 100 when the torque has a magnitude of a predetermined value or greater. The torque limiter 6 is disposed radially outside the damper unit 7.

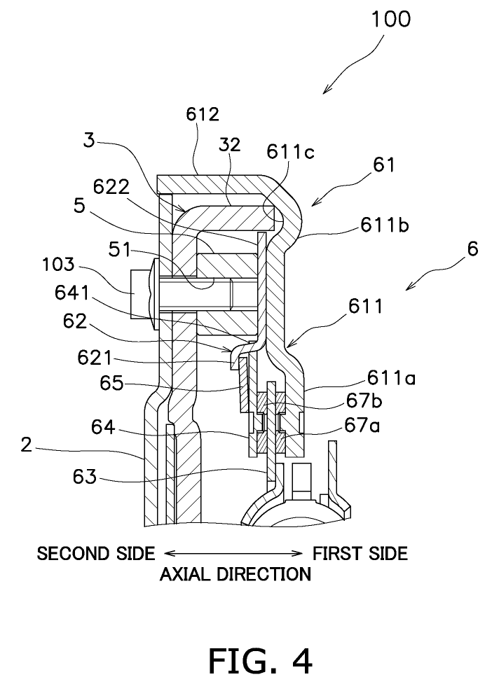

FIG. 4 is an enlarged cross-sectional view of the power transmission device. As shown in FIG. 4, the torque limiter 6 includes the first side plate 61, the second side plate 62, a friction plate 63, a pressure plate 64, and an urging member 65.

### First Side Plate

The first side plate 61 is disposed on the first side of the drive plate 3 in the axial direction. The first side plate 61 is attached to the flexible plate 2. Specifically, the first side plate 61 is attached to the flexible plate 2 through the drive plate 3 and the inertia blocks 5, both of which are fixed to the flexible plate 2.

The bolts 104 are screwed into the threaded holes 51 of the first inertia blocks 5a, whereby the first and second side plates 61 and 62 are fixed to the first inertia blocks 5a. The first side plate 61 has an annular shape.

The first side plate 61 includes the second annular portion 611 and the second cylindrical portion 612. The second annular portion 611 and the second cylindrical portion 612 are integrated as a single member.

The second annular portion 611 is made in the shape of an annulus extending in the circumferential direction. The second annular portion 611 includes a first inner peripheral portion 611a and the first outer peripheral portion 611b. The first inner peripheral portion 611a is in contact with the friction plate 63. The first inner peripheral portion 611a is disposed on the first side of the first outer peripheral portion 611b in the axial direction. The first outer peripheral portion 611b is disposed radially outside the first inner peripheral portion 611a. The first outer peripheral portion 611b overlaps with the inertia blocks 5 as seen in the axial direction.

The second annular portion 611 includes a recess 611c made in the shape of an annulus extending in the circumferential direction. The recess 611c recesses in a direction separating from the drive plate 3. In other words, the recess 611c recesses to the first side in the axial direction. The recess 611c is opposed to the first cylindrical portion 32 as seen in the axial direction. The distal end of the first cylindrical portion 32 is disposed in the recess 611c.

The second cylindrical portion 612 extends from the outer peripheral end of the second annular portion 611 in the axial direction. When described in detail, the second cylindrical portion 612 extends from the outer peripheral end of the second annular portion 611 to the second side in the axial direction. In other words, the second cylindrical portion 612 extends from the outer peripheral end of the second annular portion 611 toward the flexible plate 2 in the axial direction.

The second cylindrical portion 612 is disposed radially outside the first cylindrical portion 32. The second cylindrical portion 612 overlaps with the first cylindrical portion 32 as seen in the radial direction. The second cylindrical portion 612 is larger in length than the first cylindrical portion 32. The second cylindrical portion 612 covers the entity of the outer peripheral surface of the first cylindrical portion 32. The second cylindrical portion 612 serves as the outer peripheral surface of the power transmission device 100. The second cylindrical portion 612 extends to the position of the flexible plate 2 in the axial direction. The outer peripheral surface of the flexible plate 2 is in contact with the inner peripheral surface of the second cylindrical portion 612.

The second cylindrical portion 612 is formed by bending an outer peripheral part of the first side plate 61 to the second side in the axial direction. Because of this, the second cylindrical portion 612 is substantially equal in plate thickness to the second annular portion 611. It should be noted that the first side plate 61 can be set to have a plate thickness of, for instance, about 2.0 mm to 8.0 mm.

The first side plate 61 can be made of a steel plate or so forth; specifically, the first side plate 61 can be made of a cold-rolled steel plate (SPCC; Steel Plate Cold Commercial), a hot-rolled steel plate (SPHC; Steel Plate Hot Commercial), a hot-rolled steel plate or sheet for automobile structural use (SAPH; Steel Automobile Press Hot), or so forth. The first side plate 61 can be formed by sheet metal processing or stamping of a steel plate. Specifically, the first side plate 61 can be formed by single-stage stamping, progressive stamping, or transfer stamping.

### Second Side Plate

The second side plate 62 is disposed on the second side of the first side plate 61 in the axial direction. In other words, the second side plate 62 is disposed axially between the drive plate 3 and the first side plate 61. When described in detail, the second side plate 62 is disposed in a space defined by the first annular portion 31, the first cylindrical portion 32, and the second annular portion 611.

The friction plate 63, the pressure plate 64, and the urging member 65 are disposed axially between the first and second side plates 61 and 62. The second side plate 62 has a smaller plate thickness than the first side plate 61.

The second side plate 62 is configured to be rotated unitarily with the first side plate 61. The second side plate 62 is fastened to the first side plate 61 by a plurality of fastening members 66 (see FIG. 1). The fastening members 66 are disposed at intervals in the circumferential direction. The fastening members 66 are, for instance, rivets or bolts. The first and second side plates 61 and 62 are fixed to the first inertia blocks 5a by the bolts 104, while being fastened to each other by the fastening members 66 as herein described.

The second side plate 62 includes a second inner peripheral portion 621 and the second outer peripheral portion 622. The second inner peripheral portion 621 supports the urging member 65. The second inner peripheral portion 621 is disposed on the second side of the second outer peripheral portion 622 in the axial direction. The second inner peripheral portion 621 is disposed away from the first inner peripheral portion 611a at an interval in the axial direction. The friction plate 63, the pressure plate 64, and the urging member 65 are disposed axially between the first and second inner peripheral portions 611a and 621.

The second outer peripheral portion 622 is disposed radially outside the second inner peripheral portion 621. The second outer peripheral portion 622 is in contact with the first outer peripheral portion 611b in the axial direction. The second outer peripheral portion 622 is held by the first outer peripheral portion 611b and the inertia blocks 5, while being axially interposed therebetween. It should be noted that another member may be interposed between the inertia blocks 5 and the second outer peripheral portion 622.

The outer peripheral surface of the second side plate 62 is opposed to the inner peripheral surface of the first cylindrical portion 32. The outer peripheral surface of the second side plate 62 may be in contact with the inner peripheral surface of the first cylindrical portion 32, or alternatively, may be disposed away therefrom at an interval.

### Friction Plate

As shown in FIGS. 1 and 4, the friction plate 63 is a plate made in the shape of an annulus extending in the circumferential direction. The friction plate 63 is disposed to be rotatable about the rotational axis O. The friction plate 63 is disposed to be rotatable relative to the first side plate 61.

The friction plate 63 is in contact with the first side plate 61 in the axial direction. When described in detail, the friction plate 63 is in contact with the first inner peripheral portion 611a of the second annular portion 611 in the axial direction. When described in more detail, the friction plate 63 is in contact with a first friction material 67a attached to the first side plate 61. The first friction material 67a is rotated unitarily with the first side plate 61. It should be noted that the first friction material 67a may be attached to the friction plate 63. The friction plate 63 is configured to be engaged by friction with the first side plate 61.

The friction plate 63 is attached to a first rotary member 71 of the damper unit 7 (to be described). When described in detail, the friction plate 63 is attached to a second plate 71b. For example, the friction plate 63 is attached to the second plate 71b by a plurality of fastening members 105. The friction plate 63 is rotated unitarily with the first rotary member 71. It should be noted that the friction plate 63 is provided as a discrete member separated from the second plate 71b; alternatively, the friction plate 63 may be integrated with the second plate 71b as a single member.

### Pressure Plate

The pressure plate 64 has an annular shape. The pressure plate 64 is disposed axially between the urging member 65 and the friction plate 63. The pressure plate 64 holds the friction plate 63 in cooperation with the first side plate 61, with the friction plate 63 interposed therebetween.

The pressure plate 64 is configured to be rotated unitarily with the first side plate 61. It should be noted that the pressure plate 64 is axially movable with respect to the first side plate 61. Specifically, the pressure plate 64 includes a plurality of protruding portions 641 protruding radially outward. The protruding portions 641 are engaged with engaging holes provided in the second side plate 62, respectively, whereby the pressure plate 64 is rotated unitarily with the second side plate 62, while being axially movable with respect thereto. The second side plate 62 is rotated unitarily with the first side plate 61 but is axially immovable with respect thereto; hence, the pressure plate 64 is rotated unitarily with the first side plate 61, while being axially movable with respect thereto.

The pressure plate 64 is provided with a second friction material 67b attached thereto. When rotated relative to the pressure plate 64, the friction plate 63 slides against the second friction material 67b. It should be noted that the second friction material 67b may be attached to the friction plate 63.

### Urging Member

The urging member 65 is disposed axially between the second side plate 62 and the pressure plate 64. The urging member 65 urges the pressure plate 64 to the first side in the axial direction. In other words, the urging member 65 urges the pressure plate 64 toward the first side plate 61. Accordingly, the friction plate 63 is sandwiched by the pressure plate 64 and the first side plate 61. The urging member 65 is made in the shape of an annulus extending in the circumferential direction. The urging member 65 is, for instance, a disc spring. The urging member 65 is in contact at an outer peripheral end portion thereof with the second inner peripheral portion 621, while being in contact at an inner peripheral end portion thereof with the pressure plate 64.

### Damper Unit

As shown in FIG. 1, the damper unit 7 is attached to the flexible plate 2. When described in detail, the damper unit 7 is attached to the torque limiter 6. In other words, the damper unit 7 is attached to the flexible plate 2 through the torque limiter 6 and the inertia blocks 5. The damper unit 7 is configured to attenuate fluctuations in rotation. The damper unit 7 includes the first rotary member 71, a second rotary member 72, and a plurality of elastic members 73.

### First Rotary Member

The first rotary member 71 is configured to receive the torque outputted from the flexible plate 2. When described in detail, the first rotary member 71 receives the torque outputted from the flexible plate 2 through the torque limiter 6. The first rotary member 71 is rotated unitarily with the friction plate 63 of the torque limiter 6. The first rotary member 71 includes a first plate 71a and the second plate 71b. Each of the first and second plates 71a and 71b is an annular member including a center hole. The first and second plates 71a and 71b are rotated unitarily with each other. Besides, the first and second plates 71a and 71b are axially immovable relative to each other. The first and second plates 71a and 71b are fastened to each other by a plurality of fastening members 106.

The first and second plates 71a and 71b are disposed away from each other at an interval in the axial direction. The second plate 71b is disposed on the second side of the first plate 71a in the axial direction.

The first plate 71a includes a plurality of window portions 711a, while the second plate 71b includes a plurality of window portions 711b. It should be noted that in the present preferred embodiment, the first plate 71a includes four window portions 711a, while the second plate 71b includes four window portions 711b; however, the window portions 711a, 711b are not limited in number to this.

Not only the window portions 711a but also the window portions 711b are disposed away from each other at intervals in the circumferential direction. Not only the window portions 711a but also the window portions 711b are configured to accommodate the elastic members 73, respectively.

The first rotary member 71 overlaps at an outer peripheral part thereof with friction surfaces, at which the friction plate 63 and the first side plate 61 are in contact with each other, as seen in the axial direction. The outer peripheral part of the first rotary member 71 is disposed on the first side of the torque limiter 6 in the axial direction.

### Second Rotary Member

The second rotary member 72 is configured to transmit the torque, outputted thereto from the first rotary member 71, to the output-side member. The second rotary member 72 is disposed axially between the first and second plates 71a and 71b. The second rotary member 72 is disposed to be rotatable relative to the first and second plates 71a and 71b.

The second rotary member 72 includes a hub 721 and a flange plate 722. The hub 721 and the flange plate 722 are separated as different members; alternatively, the hub 721 and the flange plate 722 may be integrated as a single member.

The hub 721 has a tubular shape and extends in the axial direction. The hub 721 is disposed in the center hole of the first plate 71a and that of the second plate 71b. The hub 721 is provided with a spline hole, extending in the axial direction, in an inner peripheral part thereof. The spline hole enables an input shaft of the output-side member to be spline-coupled thereto.

The flange plate 722 radially extends from the outer peripheral surface of the hub 721. The flange plate 722 has an annular shape. The flange plate 722 is disposed to be rotatable relative to the first and second plates 71a and 71b. The flange plate 722 is disposed axially between the first and second plates 71a and 71b.

The flange plate 722 includes a plurality of accommodation holes 723. It should be noted that in the present preferred embodiment, the flange plate 722 includes four accommodation holes 723; however, the accommodation holes 723 are not limited in number to this. The accommodation holes 723 are disposed away from each other at intervals in the circumferential direction. The accommodation holes 723 are configured to accommodate the elastic members 73, respectively. The accommodation holes 723 are set in place to overlap with not only the window portions 711a but also the window portions 711b, respectively, as seen in the axial direction.

### Elastic Members

The elastic members 73 are configured to elastically couple the first and second rotary members 71 and 72 in a rotational direction. The elastic members 73 are, for instance, coil springs.

The elastic members 73 are accommodated in the accommodation holes 723 of the second rotary member 72, respectively. Besides, the elastic members 73 are accommodated in not only the window portions 711a of the first plate 71a but also the window portions 711b of the second plate 71b, respectively. The elastic members 73 are disposed radially inside the torque limiter 6.

As described above, in the preferred embodiment described above, the drive plate 3, having a larger plate thickness than the flexible plate 2, is attached to the flexible plate 2. The drive plate 3 is enabled to function as at least a part of an inertia ring used in a conventional power transmission device. Because of this, the power transmission device 100 is obtainable at a low cost, while the inertia ring is omitted at least in part. For example, in the present preferred embodiment, the plural inertia blocks 5, disposed at intervals in the circumferential direction, are employed instead of the inertia ring, whereby the power transmission device 100 is obtainable at a low cost.

In the preferred embodiment described above, the inner peripheral end of the drive plate 3 is disposed radially inside the protruding portion 21 of the flexible plate 2; hence, the drive plate 3 can be enhanced in stiffness. Besides, the disc spring 4 can be limited in amount of bending by the inner peripheral part of the drive plate 3.

### Modifications

One preferred embodiment of the present invention has been explained above. However, the present invention is not limited to the above, and it will be apparent to one of ordinary skill in the art from this disclosure that a variety of changes can be made without departing from the gist of the present invention. It should be noted that basically speaking, respective modifications to be described are applicable separately or in combination in an embodiment.

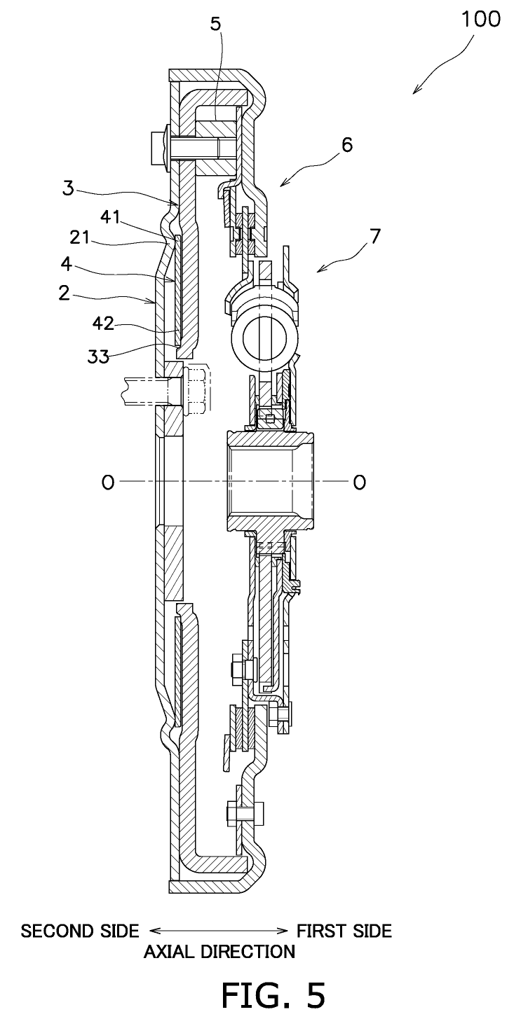

(a) As shown in FIG. 5, the disc spring 4 may be in contact at an outer peripheral end portion 41 with the protruding portion 21; besides, the disc spring 4 may be in contact at an inner peripheral end portion 42 with the drive plate 3. In this case, the stepped portion 33 of the drive plate 3 may be in contact with the inner peripheral surface of the disc spring 4.

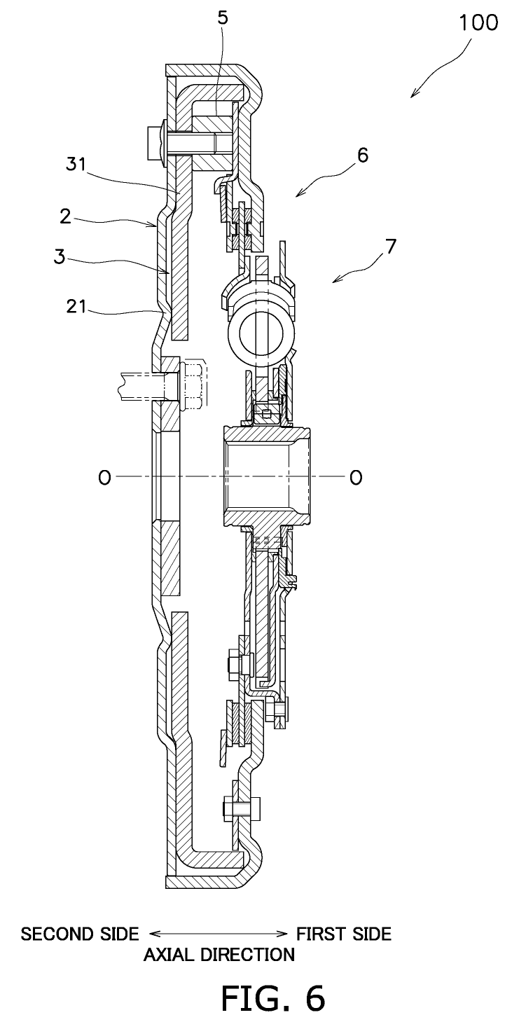

(b) As shown in FIG. 6, the power transmission device 100 may not include the disc spring 4. In this case, the protruding portion 21 of the flexible plate 2 is in contact with the drive plate 3. When described in detail, the protruding portion 21 is in contact with an inner peripheral part of the first annular portion 31 of the drive plate 3. It should be noted that the inner peripheral part of the first annular portion 31 of the drive plate 3 is disposed away from the flexible plate 2, except for the protruding portion 21, at an interval in the axial direction.

Thus, the protruding portion 21 is in contact with the drive plate 3; hence, when the flexible plate 2 bends in the axial direction during the operation of the power transmission device 100, the protruding portion 21 slides against the drive plate 3, whereby an occurrence of resonance can be inhibited.

(c) In the preferred embodiment described above, the damper unit 7 is attached to the inertia blocks 5 through the torque limiter 6; however, the power transmission device 100 is not limited in configuration to this. For example, the damper unit 7 may be directly attached to the inertia blocks 5 without being connected via the torque limiter 6. In other words, the power transmission device 100 may not include the torque limiter 6. In this case, the first rotary member 71 of the damper unit 7 is attached to the inertia blocks 5.

(d) In the preferred embodiment described above, the power transmission device 100 includes the plural inertia blocks 5; however, the power transmission device 100 is not limited in configuration to this. For example, the power transmission device 100 may include an inertia ring instead of the inertia blocks 5. The inertia ring is made in the shape of an annulus extending in the circumferential direction. In this case, the power transmission device 100 includes the drive plate 3; hence, the inertia ring can be made smaller in thickness, diameter, and so forth than a conventional inertia ring. As a result, the power transmission device 100 is obtainable at a low cost.

Alternatively, the power transmission device 100 may not include both the inertia blocks 5 and the inertia ring. In other words, the torque limiter 6 may be directly attached to the flexible plate 2 or the drive plate 3.

(e) In the present preferred embodiment described above, the drive plate 3 is disposed on the first side of the flexible plate 2 in the axial direction; alternatively, the drive plate 3 may be disposed on the second side of the flexible plate 2 in the axial direction. In this case, the protruding portion 21 of the flexible plate 2 protrudes to the second side in the axial direction.

### LIST OF REFERENCE NUMERALS

2: Flexible plate, 21: Protruding portion, 3: Drive plate, 31: First annular portion, 32: First cylindrical portion, 4: Disc spring, 41: Outer peripheral end portion, 42: Inner peripheral end portion, 5: Inertia block, 6: Torque limiter, 61: First side plate, 611: Second annular portion, 612: Second cylindrical portion, 63: Friction plate, 64: Pressure plate, 65: Urging member, 7: Damper unit, 71: First rotary member, 72: Second rotary member, 73: Elastic member, 100: Power transmission device.

The term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “plurality,” as used herein, can encompass the configuration in which each element of a plurality of elements has a different shape or structure from each other in addition to the configuration in which the plurality of elements have the same shapes or structures as each other.

The terms “a” (or “an”), “one or more” and “at least one” can be used interchangeably herein. The phrase “at least one of” as used in this disclosure means “one or more” of a desired choice.

Terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Modifications and variations of the present invention will be apparent to one of ordinary skill in the art in light of this disclosure. It is therefore to be understood that within the scope of the appended claims, the invention may be practiced otherwise than as specifically described herein.

1. A power transmission device comprising:
a flexible plate configured to receive a torque outputted from a prime mover; and
a drive plate configured to be rotated unitarily with the flexible plate,
the flexible plate including a protruding portion protruding toward the drive plate in an axial direction, and
the drive plate having an annular shape, the drive plate being disposed radially inside the protruding portion at an inner peripheral end thereof, and the drive plate having a larger plate thickness than the flexible plate.

2. The power transmission device according to claim 1, further comprising:
a disc spring disposed between the flexible plate and the drive plate in the axial direction; and
the disc spring is in contact with the protruding portion and the drive plate.

3. The power transmission device according to claim 2, wherein the disc spring is in contact at an outer peripheral end portion thereof with the drive plate, the disc spring being in contact at an inner peripheral end portion thereof with the protruding portion.

4. The power transmission device according to claim 2, wherein the disc spring is in contact at an outer peripheral end portion thereof with the protruding portion, the disc spring being in contact at an inner peripheral end portion thereof with the drive plate.

5. The power transmission device according to claim 1, wherein the drive plate is in contact with the protruding portion.

6. The power transmission device according to claim 1, wherein the drive plate includes an annular portion and a cylindrical portion, the annular portion extending in a circumferential direction, the cylindrical portion extending from an outer peripheral end of the annular portion in the axial direction.

7. The power transmission device according to claim 1, further comprising:
an inertia member configured to be rotated unitarily with the flexible plate and the drive plate.

8. The power transmission device according to claim 1, further comprising:
a torque limiter attached to the flexible plate.

9. The power transmission device according to claim 8, wherein the torque limiter includes
a first side plate attached to the flexible plate,
a friction plate disposed to be rotatable relative to the first side plate,
a pressure plate holding the friction plate in cooperation with the first side plate, with the friction plate interposed therebetween, and
an urging member urging the pressure plate toward the first side plate in the axial direction.

10. The power transmission device according to claim 9, wherein the first side plate includes an annular portion and a cylindrical portion, the annular portion extending in a circumferential direction, the cylindrical portion extending from an outer peripheral end of the annular portion toward the flexible plate in the axial direction.

11. The power transmission device according to claim 10, wherein the cylindrical portion serves as an outer peripheral surface of the power transmission device.

12. The power transmission device according to claim 10, wherein the flexible plate is in contact with an inner peripheral surface of the cylindrical portion.

13. The power transmission device according to claim 1, further comprising:
a damper unit attached to the flexible plate, wherein
the damper unit includes
a first rotary member receiving the torque from the flexible plate,
a second rotary member disposed to be rotatable relative to the first rotary member, and
an elastic member elastically coupling the first and second rotary members therethrough to each other.

14. The power transmission device according to claim 2, wherein the drive plate includes an annular portion and a cylindrical portion, the annular portion extending in a circumferential direction, the cylindrical portion extending from an outer peripheral end of the annular portion in the axial direction.

15. The power transmission device according to claim 2, further comprising:
an inertia member configured to be rotated unitarily with the flexible plate and the drive plate.

16. The power transmission device according to claim 3, wherein the drive plate includes an annular portion and a cylindrical portion, the annular portion extending in a circumferential direction, the cylindrical portion extending from an outer peripheral end of the annular portion in the axial direction.

17. The power transmission device according to claim 3, further comprising:
an inertia member configured to be rotated unitarily with the flexible plate and the drive plate.

18. The power transmission device according to claim 1, further comprising:
a torque limiter attached to the flexible plate.

19. The power transmission device according to claim 11, wherein the flexible plate is in contact with an inner peripheral surface of the cylindrical portion.

20. The power transmission device according to claim 2, further comprising:
a damper unit attached to the flexible plate, wherein
the damper unit includes
a first rotary member receiving the torque from the flexible plate,
a second rotary member disposed to be rotatable relative to the first rotary member, and
an elastic member elastically coupling the first and second rotary members therethrough to each other.
